(19) United States
(12) Patent Application Publication
(10) Pub. No.: US 2005/0118402 A1
(43) Pub. Date: Jun. 2, 2005

(54) Camouflage covering

(76) Inventors: William Henderson, Battle (GB); Michael Cheese, Rochester (GB); Allan Marshall, Hudson, OH (US)

Correspondence Address: Chief Intellectual Property Counsel;Omnova Solutions Inc, 175 Ghent Road, Fair Lawn, OH, 44333-3300, US

(21) Appl. No.: 10/512,002

(22) PCT Filed: Apr. 22, 2003
(86) PCT No.: PCT/US03/12474

(30) Foreign Application Priority Data
Apr. 23, 2002 (GB) 020924.7

(51) Int. Cl. B32B 3/00; B32B 15/00

(52) U.S. Cl. 428/209; 428/195.1; 428/457; 428/458

(57) ABSTRACT

A covering for application on surfaces of a structure, includes at least one sheet including a plurality of components, each component being capable of protecting the structure against detection by at least one sensing method. The sheet can have an adhesive exterior surface whereby it can be adhered to the structure and wherein the exterior surface opposite the adhesive surface has an uneven surface profile.

### BACKGROUND INFORMATION

Protecting a structure such as a building or a vehicle from detection often is desirable. Many means of camouflaging objects are known in the fields of surveillance and wildlife observation.

Some of these involve protection that is built-in to the structure in question. For example, GB 565,238 describes a process and means for coating objects for the purpose of camouflage. A paint-like coating is applied which protects the objects from detection in the visible and infrared (IR) portions of the electromagnetic spectrum. This type of built-in camouflages is effective against visual detection only in areas with natural color(s) that match closely those of the camouflage system. For example, a temporary building painted with a sand-colored coating would be camouflaged in desert situations but would stand out against a jungle environment; thus, the structure would require repainting when moved from one environment to another.

Other means involve removable protection such as, e.g., a camouflage net. In this respect, U.S. Pat. No. 5,549,938 describes flexible magnetic panels having camouflage patterns provided thereon. The panels are designed to magnetically attach to steel surfaces such as the panels of a vehicle, reducing the chance of visual detection of the vehicle. Such removable camouflage panels are convenient to apply or remove but are designed to protect an object only against visual detection. Surveillance equipment or animals with the ability to detect UV or IR emissions, for example, can detect the presence of an object protected by such panels.

Yet another means is a semi-permanent type, such as a demountable screen for shielding. In this respect, U.S. Pat. No. 4,560,595 discloses a camouflage sheet material designed to have thermal emission characteristics which match closely those of the natural environment in which the camouflage material is to be used. The sheet can protect objects against detection in the thermal IR wavelength ranges and is also adapted to provide camouflage in the ultraviolet (UV), visible and photographic IR wavelengths. The camouflage material may be attached to a supporting web by means of an adhesive or by mechanical means such as clamps or sewing. This type of sheet material cannot be applied easily and quickly to a structure because it first must be attached to a supporting web and then somehow attached to a structure to be protected. If the structure is, e.g., a vehicle, the sheet must be securely attached to the vehicle to prevent it from releasing when the vehicle moves.

It is often important that a camouflage covering be robust against severe weather and remain in place and undamaged for extended periods of time.

A brief discussion will now be given of sensing methods available for detecting objects, and of protection means available to protect against detection.

Detection in the visible portion of the spectrum is used, both by land-based surveillance systems or individuals and by satellites, to detect the presence of objects. The nature of an area surrounding an object dictates the type of camouflage cover required to protect against visual detection. The earlier examples of desert and jungle situations would require sand-colored and patterned green coverings respectively. It is often desirable that the color of a surface change rapidly for a camouflage system to adapt to new surroundings.

Similarly, the surface texture of an object can affect whether an object is easy or difficult to detect visibly. Surface profiling can be used to protect objects against detection by aerial imaging. If a surface of an object is uneven, light scatters unevenly (i.e., differently from different parts) thus breaking up the lines of the object and rendering it difficult to detect. Shadows created by an object also can be minimized by suitable use of uneven surface profiles.

The shape of objects also can be important. Many vehicles and buildings are designed to have stealthy shapes comprising multiple oriented flat panels which are not easily detected. An irregularity in the shape of a surface can render the surface susceptible to detection. For example, a bolt protruding from an otherwise smooth surface can give a strong signal on imaging equipment in certain parts of the electromagnetic spectrum.

UV sensors can detect an object that transmits a UV signature substantially different from that of its surroundings. UV pigments can be used to give the surface of an object the correct properties such that it cannot easily be observed by UV sensors.

In an analogous manner, IR signatures of objects can make them easy to detect, and pigments again can be used to give an object apparently similar IR properties to that of its surroundings. Alternatively, reflective metallic layers can be incorporated beneath a colored but IR transmissive polymer (e.g., polyethylene or polypropylene) film.

Thermal imaging can be used to detect objects via the (IR) heat that they produce. Metallized particles or fibers (scrim) incorporated into a material, or a metallized film applied over the same, can be used to reflect heat produced in the object back toward the source so that the external surface of the object is not seen as producing a great deal of heat. An example of a situation in which this effect might be useful is in protecting a moving vehicle from detection while the engine of the vehicle radiates a large amount of heat.

In addition, or alternatively, phase change materials (PCMs) can be used to absorb heat from hot spots of objects. For instance, a PCM which operates at a high temperature could be used to smooth out the heat signature of a boiler housing.

Radar is also used in surveillance systems to detect objects. To avoid detection by this method, radar-absorbing materials (RAMs) can be used in camouflage coverings.

Absorption of acoustic signals also often is desirable. Materials such as high density foam, rubber and ceramics can be effective for this purpose.

Providing a camouflage covering that can be applied quickly, easily and securely to an object to be protected and that can provide protection against a range of detection means remains desirable.

### SUMMARY OF THE INVENTION

Briefly, the present invention provides including at least one sheet having a plurality of components, each component being capable of protecting a structure against detection by at least one sensing method. The sheet has an adhesive exterior surface whereby it can adhere to the structure and, opposite the adhesive surface, an exterior surface with an uneven surface profile.

A backing sheet can be removably attached to the adhesive surface such that the backing sheet can be removed to expose the adhesive surface. The covering then can be applied directly to a surface of an object to be protected. The covering subsequently can be removed from the object without damaging it.

The covering can include UV and/or IR pigments. Also, it can include a metallized scrim, the threads of which could be metallized with Al, Ni, Cu, or chrome.

The covering can include one or more radio absorbing material such as carbonyl iron, aramid fibers, ferrites, or carbon loaded foams. Suitable classes of RAMs include Salisbury screens, Jaumann absorbers, circuit analog absorbers, magnetic RAM and Hybrid RAM systems. Additionally, the covering can include a flexible soft-magnetic thin film which can act as both a radar absorber and an IR reflector. Suitable examples of magnetic films include alloys of Co, Fe, Si, Mo, and Bo and/or Co, Zr, and Nb. One component of the covering could suitably comprise a PCM such as hydrated AlCl₃, hydrated MgCl₂, or Glauber's salt.

The covering also can suitably include an acoustic absorber made of a material as described previously.

The sheet preferably is flexible so that it can be rolled up for easy transportation, storage, application and manipulation.

The covering can include a plurality of layers each provides protection against detection by at least one sensing method. One of the layers can be a paint layer applied directly to the object to be protected or to a surface of the covering itself. Suitably, at least one of the layers of such a multilayer covering can be removably adhered to an adjacent layer. Adhesive layers could be provided between each of the layers. This convertibility/removability feature of might be useful in situations where altering the visual appearance of a covering while leaving the other camouflage functions of the covering unchanged is required. For example, a sand-colored upper layer could be removed from a covering at a time when the covering is no longer to be used in a desert environment but is instead to be used in a vegetated area. This can eliminate the need to remove the entire covering, which may still be in good condition after extended use; instead, the outer layer could be peeled off and replaced by a similar outer layer of a different pattern or color to suit the new environment.

According to a second aspect, the present invention provides a method for protecting a structure. The method includes applying to a surface of the structure a covering having any combination of the features as set out above in relation to the first aspect of the invention.

According to a third aspect, the present invention provides a camouflage system that includes first and second coverings as just described with the second covering being removably adhered to the first.

In a fourth aspect, the present invention provides a kit for camouflaging surfaces that includes a first elongate sheet patterned with two zones, the zones having different appearances, each zone extending along a relatively long dimension of the sheet, wherein one side of each zone runs continuously along a respective side of the sheet, and the other side of each zone is delimited by a boundary extending along the relatively long dimension of the sheet in a generally undulating form. All regions of the sheet on one side of the boundary form a zone of a first appearance and all regions of the sheet on the other side of the boundary form a zone of a second appearance; and a second elongate sheet having a continuous field of the first appearance within which are disposed isolated regions of the second appearance. The two sheets can be subdivided with resulting sections from each being capable of being joined so as to form a camouflage pattern.

In yet another aspect, the present invention provides a method for forming a covering for application on surfaces of a structure. The method includes digitally printing a non-repeating camouflage pattern onto a covering having any one or more of the features set out above.

### BRIEF DESCRIPTION OF THE DRAWINGS

In the accompanying drawings, like reference numerals refer to like parts.

FIG. 1 shows a cross section of a camouflage covering according to the present invention which includes several components.

FIG. 2 shows a camouflage covering that includes an adhesive surface with a removable backing sheet.

FIG. 3 shows an unprotected building exposed to light.

FIG. 4 shows a building protected by a camouflage covering being exposed to light.

FIG. 5 shows the heat signature of an unprotected boiler house.

FIG. 6 shows the heat signature of a boiler house protected by a covering comprising a PCM and metallized scrim.

FIG. 7 shows two sheets including multi-zone patterns in accordance with the fourth aspect of the invention described above.

FIG. 8 shows portions cut from the sheets from FIG. 7.

FIG. 9 shows the combination resulting when the strips from FIG. 8 are combined.

### DETAILED DESCRIPTION

FIG. 1 shows covering 1 with several components 10-15, each of which can provide protection against detection for a covered object. Any combination of the components shown may be used in a camouflage covering; other components having similar or different camouflage properties can be incorporated in a similar manner.

Component 10 is a painted or printed layer. The layer may be patterned, and is of one or more colors that provide limited contrast with the surroundings of the structure to which covering 1 is to be applied. The pattern of the painted or printed layer is intended to make difficult visual detection of a structure within a pre-decided (visible) wavelength range.

Further layers of paint or adhesive printed sheets may be applied to layer 10 to change the color of the covering to match different surroundings. Layer 10 may be digitally printed to give a camouflage color and pattern most suited to a specific operational environment. The color and pattern could be generated from a set of real background images by, for example, analysis of such images to establish a form of pattern that has low contrast against the background and then forming images of that form by means of a suitable algorithm or pseudo-random procedure. Covering sheets could be individually printed for disguising specific objects against their backgrounds. With digital printing, sheets can be printed with a non-repeating pattern, which can make the sheets less prone to detection.

Component 11 is a surface which has been embossed to give a profiled structure. The profiled structure has a degree of surface relief and/or unevenness which acts to scatter light and other electromagnetic wavelengths from the covering to break up the outer surface of a structure to which the covering is to be applied. Embossed surface 11 is useful in protecting a structure against detection by visible (aerial), IR and RADAR imaging.

The dimensions of the indentations determine the frequencies of radiation against which the covering can best protect. Preferably, the dimensions of the features of the surface profile—the depth of grooves, the height of protrusions, and/or the spacing between them—are approximately half the wavelength of the radiation against which protection is desired. If, for example, protection against IR detection is desired, the features of the surface relief should be of the order of 0.4 to 500 μm, e.g., 200 μm.

Additionally, the surface profile can be used to disrupt the shadow of a structure. For this purpose the dimensions of the features of the surface relief should be of a scale of approximately 1 to 50 cm. The relief could be provided by an array of comb-like projections from the surface of the covering.

To deflect radar, the surface indentations should preferably be regularly shaped, and around 1 mm deep. Again, preferably the dimensions of the features of surface relief are approximately half the wavelength.

Component 12 contains UV and/or IR pigments which provide the surface of a protected structure with UV and/or IR signatures resembling those of its surroundings, thus protecting the structure against detection by UV and/or IR sensors. Alternatively, a metallic film positioned beneath a pigmented, IR transmissive film can be used to the same effect.

Component 13 includes a PCM which preferably changes phase at a working temperature in such a way that the phase change is endothermic upon increasing temperature. In this way, the PCM acts as a thermal buffer. Preferably, the working temperature of the material is around the upper or lower limit of the expected ambient temperature at the location where the covering is to be used. Layer 13 acts to absorb heat when it reaches the phase change temperature of the PCM, thus smoothing out the heat signature of structures containing heat-producing objects.

Component 14 is a metal film which assists heat dissipation. This also acts to smooth the heat signature of the structure being protected, by reflecting heat towards the source and thus preventing the external surface of the structure from producing a localized heat signature.

The points 15 shown in FIG. 1 represent the cross sections of metallized threads, or scrim, woven into covering 1. When a covering comprising scrim is applied over an outer surface of a structure, an effect of the scrim is to produce a Faraday cage. The inside of the structure must be electrically uncharged, such that any charge placed inside the cage is cancelled by an equal and opposite charge spread across the exterior of the cage. A structure protected by a scrim covering is therefore difficult to detect by means of electromagnetic imaging in that it prevents transmission of EM waves in or out of the structure. In addition the scrim should protect the structure from an electromagnetic pulse. The scrim also acts to reflect heat produced within the structure.

Such metallized threads can be produced by electrocatalytic deposition in which a thin layer of Cu or Al is deposited onto the surface of a fiber. As discussed above, metallized particles or a metallized film can be used in place of scrim.

An adhesive layer 16 is shown on an exterior surface of covering 1. This allows covering 1 to be applied quickly and easily to an object to be protected. The adhesive 16 could be covered by a removable backing sheet to protect the adhesive layer prior to application of the covering.

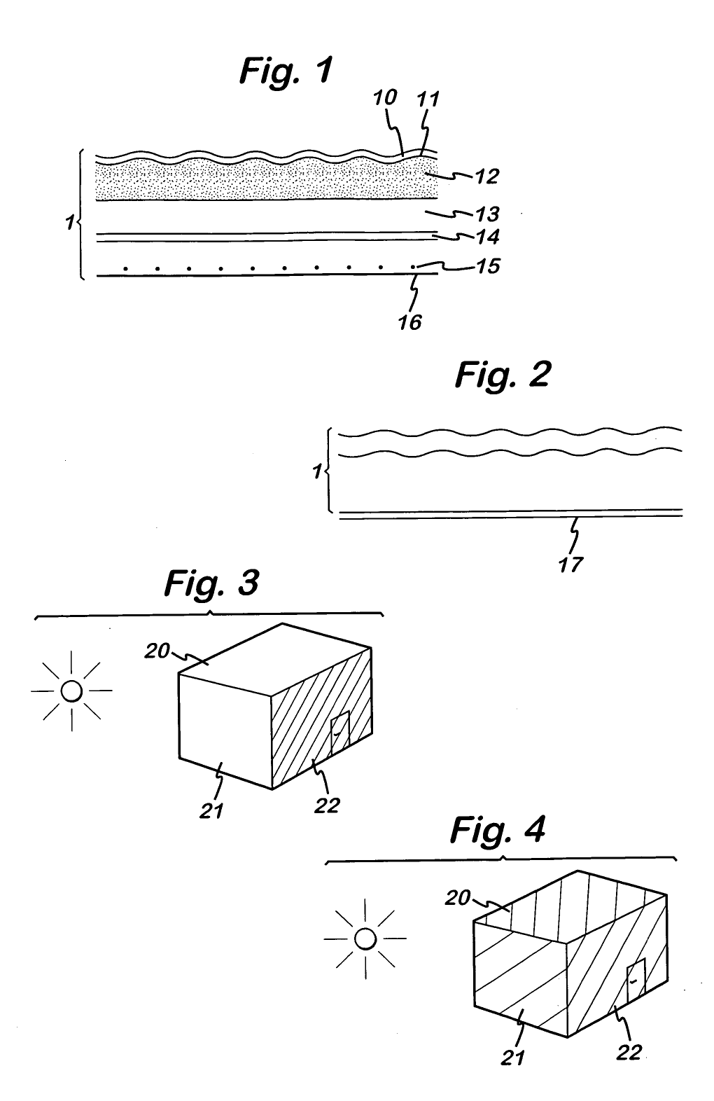

In FIG. 2, layer 17 is a backing sheet removably adhered to covering 1. This backing sheet can be peeled off for covering 1 to be adhesively applied to the surface of a structure/object.

FIG. 3 shows a building 20, such as a temporary structure erected from a flat-pack, unprotected by any camouflage covering. Building 20 is exposed to light from, say, the sun or a spotlight. The surface 22 of the building, which is shaded from the light, appears considerably darker than surface 21, which is directly exposed to the light source. This contrast in shadow allows building 20 to be detected easily by an equipment or individual scanning in the visible range of the spectrum.

To reduce this susceptibility, use can be made of embossed surfaces (11 in FIG. 1) which act to scatter light and create shadows on surfaces of the structure to be protected. The result of this effect is shown in FIG. 4 where it can be seen that surface 21 appears darker than in FIG. 3, and surface 22 appears relatively lighter.

FIG. 5 shows a boiler house 30 without any camouflage covering. A boiler is contained within the structure, and its location is shown at 31. Heat emitted by the boiler produces a heat signature as represented by contour lines 32. The source of the heat can clearly be seen, and this signature of the boiler house is in sharp contrast to the heat signature of the natural environment in which the boiler house is situated. This renders the boiler house susceptible to detection by heat sensing surveillance equipment.

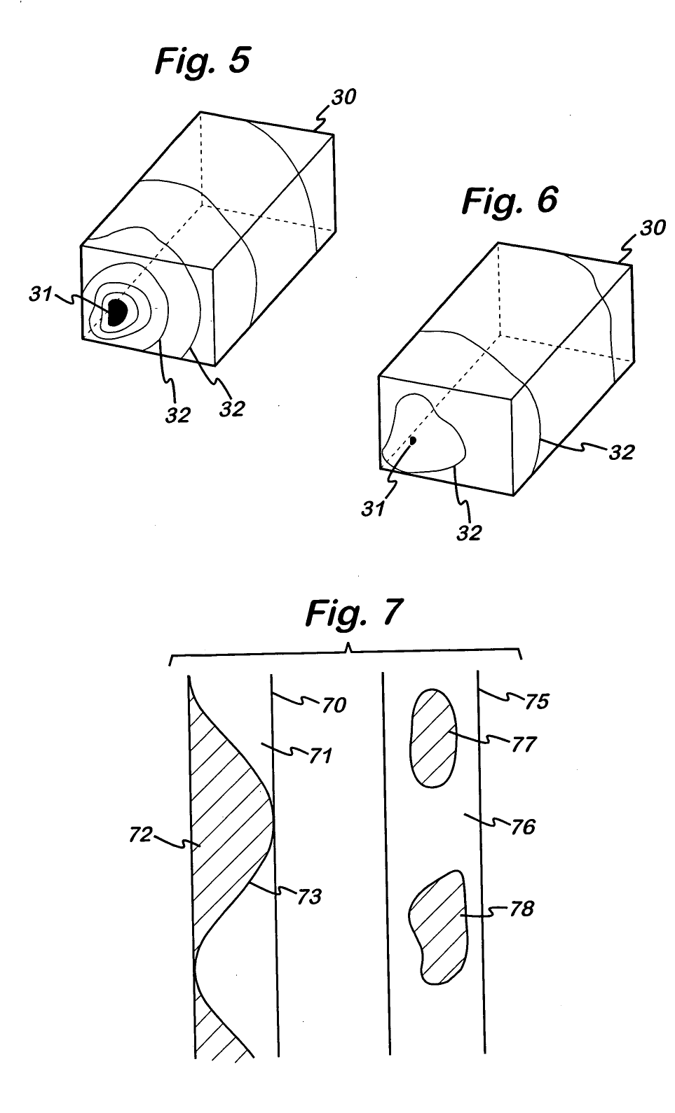

If a covering including a PCM (shown as 13 in FIG. 1) is used to protect the boiler house, the heat signature of the structure changes; FIG. 6 shows this smoother signature. A small heat source positioned at 31 still can be seen within boiler house 30, but the contour lines 33 are considerably more separated from one another than before, which makes detection by IR scanning methods less likely.

A high performance thermal insulating layer also can be included in the covering. Suitable materials for this layer would include glass fibre, microfiber or aerogels.

The inclusion in a camouflage covering including more than one of the components discussed above provides simultaneous protection from detection by multiple sensing methods. In addition, an adhesive surface allows the covering to be applied quickly and easily to a structure. It may also be adapted such that, upon removal of the covering, the underlying structure is undamaged and may subsequently be covered by a different covering. This feature would be useful in circumstances where structures are required to be frequently erected and dismantled.

The covering is conveniently in sheet form. The sheet may be formed of one or more sub-sheets laminated or adhered to one another. The sub-sheets may be bonded together either permanently or releasably by an adhesive layer carried by one or both of the sub-sheets.

In a preferred arrangement, one such sub-sheet includes one or more components that can inhibit detection by a sensing means such as radar or IR scanning (the effectiveness of which is relatively independent of the environment in which the covering may be deployed) and another includes one or more components that can inhibit detection by a sensing means such as visible observation (the effectiveness of which is relatively dependent on the environment in which the covering is to be deployed). With this system, the former sub-sheet can be applied to a structure for protection in any environment. A number of variations of the latter sub-sheet can be available for use in corresponding environments, e.g., desert, temperate, jungle, snow, etc. The latter sub-sheet is preferably deployed on the outside of the covering, further from the outer surface of the object to be protected so that its surface is exposed once the sheet has been deployed. Three or more sub-sheets, each with respective protective properties can be used.

The inner and outer sheets each can be provided with an adhesive layer on one of their major surfaces. In the case of the inner sheet, this can be used for attaching it to a structure that is to be protected; in the case of the outer sheet, this can be used for attaching it either to such a structure or to an inner sheet that has previously been adhered to the structure. The adhesive layer of the inner sheet could employ a permanent adhesive while the adhesive layer of the outer sheet could employ a releasable adhesive, or the adhesive layer of the inner sheet could be more adherent than that of the outer sheet. These configurations make it easier to apply an inner sheet to a structure and then change its appearance to match a certain environment by removing a previously deployed outer sheet and replacing it with another. A multiplicity of such inner sheets can be used, one on top of another, to provide additional protection.

The sheet(s) can be fitted with a removable protective sheet over the for the reasons stated previously.

The components that help to provide protection can be formed into a sheet or layer, embedded into a sheet, and/or sandwiched between two sheets depending on the nature of the components.

The sheet(s) can be formed from a polymer such as PVC, PVF, polypropylene, polyethylene, silicones, polysulfones, polyesters, and the like.

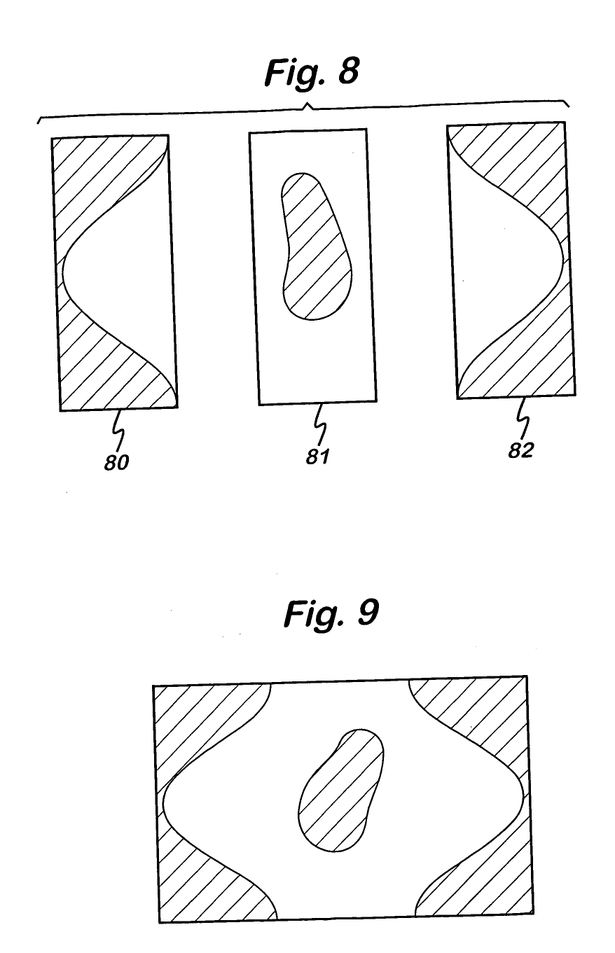

FIG. 7 shows a pair of sheets of a covering. The sheets are relatively long in one dimension and may be rolled up for storage and easy transportation in the same way as conventional wall paper. Each sheet, 70 and 75, is patterned with two zones. Each zone has a single color or multicolored pattern; for example, zones of the first type may be colored green, and zones of the second type colored brown.

Sheet 70 is patterned such that zone 72 extends along the longer dimension of the sheet. One side of zone 72 runs continuously along one side of sheet 70; the other side of zone 72 is delimited by boundary 73 extending along the longer dimension of the sheet in a generally undulating form. All regions 71 of the sheet on the other side of boundary 73 form a zone of the second type. Sheet 75 has a field 76 formed by a zone of the second type on which are disposed isolated zones 78 of the first type, shown as approximately oval.

Referring now to FIG. 8, if portions of sheets 70 and 75 are applied in a particular way to an object to be camouflaged, then a useful pattern can be obtained. Strips 80 and 82 of sheet 70 are applied along opposite sides of a surface of the object so that the zones 72 of the first type of those strips run along the edges of that surface. The region between those strips is filled with strip 81 from sheet 75. The arrangement of strips 80, 81 and 82 is shown in FIG. 8, and FIG. 9 shows an overall pattern resulting from such a combination.

The effect of such a pattern is that the sides of the surface along which the zones of the first type (strips 80 and 82 from FIG. 8) run can be camouflaged especially effectively. For example, if the color and/or pattern of the first zone of is of low contrast with the surroundings of the object, then the presence of a zone of the first type continuously along two sides of the object is likely to make it more difficult to detect. For example, in a woodland setting, if the zone of the first type is dark (e.g., black), then it can visually disrupt the edges of the object by causing confusion with nearby shadows.

A preferred configuration is shown in FIG. 9 in which the wavy boundary 73 (from FIG. 7) periodically defines wider regions of the zone of the first type, and these regions are located at the corners of the surface of the object on which the sheets are applied. This can emphasize the visual disruption at the corners of the object.

In this way, large surfaces can be covered with an effective camouflage layer without the necessity of large individual sheets. Large sheets are difficult and cumbersome to manipulate and store.

Sheets 70 and 75 could suitably be coated on the side opposite the patterned side with an adhesive layer, and the adhesive layer could conveniently be covered by a removable backing sheet. This allows for simple and quick application of the sheets in any desired arrangement.

Each individual feature has been described in isolation, but any combination of two or more such features also is to be considered as having been disclosed, to the extent that such features or combinations are capable of being carried out based on the present specification as a whole in the light of the common general knowledge of a person skilled in the art, irrespective of whether such features or combinations of features solve any problems disclosed herein. Aspects of the present invention may consist of any such individual feature or combination of features.

1. A covering for application to one or more surfaces of a structure, the covering comprising a sheet including a plurality of components, each of said components being capable of providing protection against detection by at least one sensing method, said covering having an adhesive exterior surface and an exterior surface opposite the adhesive surface having an uneven surface profile, said covering optionally further comprising a backing sheet removably adhered to the adhesive exterior surface.

2. The covering of claim 1 wherein said at least one sensing method comprises visible inspection, surface profiling, ultraviolet sensing, infrared sensing, thermal imaging, radar and acoustic.

3. The covering according to claim 1 wherein at least one of the components comprises at least one of an ultra-violet pigment, an infrared pigment, a metallic film, and metallized threads.

4. The covering according to claim 3 wherein at least one of the components comprises a metallic film and a second component adjacent the first component comprises an infrared transparent polymer.

5. The covering of claim 1 wherein at least one of the components comprises a radio absorbing material.

6. The covering of claim 1 wherein at least one of the components comprises a phase change material.

7. The covering of claim 1 wherein at least one of the components comprises an acoustic absorber.

8. The covering of claim 1 wherein said covering is flexible.

9. The covering of claim 1 wherein said covering is printed with an image representing an environmental background.

10. A system for camouflaging surfaces comprising:
a first elongate sheet patterned with two zones, the zones having different appearances, each zone extending along a primary dimension of the sheet, wherein one side of each zone runs continuously along a respective side of the sheet, and the other side of each zone is delimited by a boundary extending along the relatively long dimension of the sheet in a generally undulating form, such that all regions of the sheet on one side of the boundary form a zone of a first appearance and all regions of the sheet on the other side of the boundary form a zone of a second appearance; and
a second elongate sheet having a continuous field of the first appearance within which are disposed isolated regions of the second appearance,
each said first and second elongate sheets being capable of being sectioned with the resulting sections being capable of being joined to other sections so as to form a camouflage pattern.
